(19) United States
(12) Patent Application Publication
(10) Pub. No.: US 2011/0299551 A1
(43) Pub. Date: Dec. 8, 2011

(54) Method and Apparatus for Transferring Data Packets Between a First Network and a Second Network

(76) Inventors: Raoul Fiorone, Genova (IT); Ricardo Martinotti, Savona (IT)

(21) Appl. No.: 13/139,454

(22) PCT Filed: Dec. 18, 2008
(86) PCT No.: PCT/EP2008/067888

§ 371 Date: Aug. 26, 2011

(51) Int. Cl. H04L 12/56

(52) U.S. Cl. 370/401

(57) ABSTRACT

There is provided method and apparatus for transferring data packets between a first network and a second network using a node arrangement. The node arrangement has at least two primary nodes connected to the second network. Each primary node is connected to the first network using a respective first port and to a secondary node coupled to the second network using respective second ports. The second ports are arranged into respective link aggregation groups. The primary nodes are connected by respective inter-node ports. The method comprises the step of determining a service identifier associated with a packet received at a said primary node from the first network. The method comprises the further step of switching the packet to the second network using the respective second ports or to the other primary node using the inter-node port dependent on a service identifier associated with said packet.

### TECHNICAL FIELD

This invention relates to a method and apparatus for transferring data packets between a first network and a second network.

### BACKGROUND

Multi-chassis Link Aggregation is a link aggregation variant which allows a plurality of physical network links between two network devices and another device to be treated as a single logical link. Traffic is load balanced across all available links. For each transmitted data packet a load balancing algorithm is used to choose a physical link for the packet. This usually involves a processor carrying out a mathematical operation involving the destination media access control (MAC) address, e.g. as in Split Multi-Link Trunking (SMLT). A MAC address is an address which provides a unique identifier for a network interface card (i.e. usually a unique identifier for a single computer).

### SUMMARY

According to an aspect of the invention, there is provided a method of transferring data packets between a first network and a second network using a node arrangement having at least two primary nodes connected to the second network, each primary node being connected to the first network using a respective first port and to a secondary node coupled to the second network using respective second arranged into respective link aggregation groups; the primary nodes connected by respective inter-node ports; the method comprising:
determining a service identifier associated with a packet received at a said primary node from the first network;
switching the packet to the second network using the respective second ports or to the other primary node using the inter-node port dependent on a service identifier associated with said packet.

Advantageously, the determination of the route along which the data packet will be switched to the second network is made dependent upon the service to which it relates. This provides an advantage over systems in which the packet route is solely dependent upon MAC addresses since there may be a large number of MAC addressed devices which are provided with a single service.

Optionally, packets related to a particular service are permitted to be switched via the second ports of only some, possibly only one, of the primary nodes and the method comprises the primary nodes communicating with each other details of which of the primary nodes are permitted to switch packets related to a particular service.

Optionally, the method comprises permitting a primary node to switch packets relating to a particular service upon receipt of a packet relating to that service from the secondary node.

Optionally, the packets comprise Ethernet packets and the service identifier comprises a VLAN identification tag.

According to another aspect of the invention, there is provided a node arrangement for coupling a first network to a second network, the node arrangement comprising:
at least two primary nodes connected by respective inter-node ports;
each primary node arranged to connect to the first network using a respective first port;
each primary node arranged to connect to a secondary node coupled to the second network using respective second ports, wherein the respective second ports of each primary node are arranged into respective link aggregation groups;
each primary node being further arranged to switch packets from the first to the second network using the respective second ports or the inter-node port to the other primary node dependent on a service identifier associated with each said packet.

Optionally packets related to a particular service are permitted to be switched via the second ports of only some, possibly only one, of the primary nodes and wherein the primary nodes are arranged to communicate with each other details of which of the primary nodes is permitted to switch packets related to a particular service.

Optionally upon receipt at a primary node of a packet relating to a particular service from the secondary node, that primary node is subsequently permitted to switch packets relating to a particular service.

Optionally the packets comprise Ethernet packets and the service identifier comprises a VLAN identification tag.

According to another aspect of the invention, there is provided a system for coupling a first network to a second network, the system comprising:
a first node arrangement in communication with the first network,
a second node arrangement in communication with the second network,
the first node arrangement comprising at least two primary nodes connected by respective inter-node ports, each primary node arranged to connect to the first network using a respective first port,
the second node arrangement comprising a secondary node arranged to connect to the second network,
wherein each primary node comprises respective second ports arranged to connect to the secondary node, wherein the respective second ports of each primary node are arranged into respective link aggregation groups, and
wherein each primary node is further arranged to switch packets from the first to the second network using the respective second ports or the inter-node port to the other primary node dependent on a service identifier associated with each said packet.

Optionally, there is provided the method or system of any of the aspects of the invention wherein the primary nodes comprise switches and the secondary node comprises a router.

### BRIEF DESCRIPTION OF THE DRAWINGS

FIG. 1 shows a node arrangement and an optical network according to an embodiment of the invention;

FIG. 2 is a flow chart illustrating a method according to an embodiment of the present invention;

FIGS. 3 and 4 are flow charts illustrating methods according to further embodiments of the present invention;

FIG. 5 is a logic diagram illustrating a decision making process which occurs at a node arrangement according to an embodiment of the invention.

### DETAILED DESCRIPTION

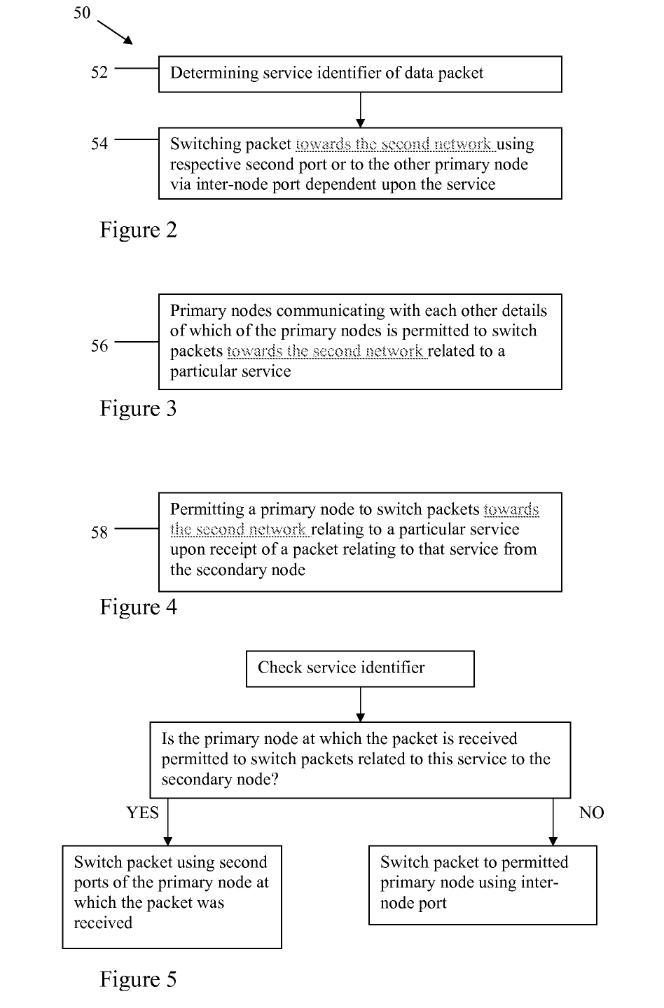

Referring to FIG. 2, an embodiment of the invention provides a method 50 of transferring data packets between a first network 12 and a second network 14 using a node arrangement 16. The node arrangement 16 has at least two primary nodes 30, 32 which are able to communicate with the second network 14. Each of the primary nodes 30, 32 is connected to the first network 12 using a respective first port 7, 8 and also to a secondary node 36 which is coupled to the second network 14 using respective second port 1, 2 and 3, 4. The respective second port 1, 2 and 3, 4 are arranged into respective link aggregation groups 20, 21, which from the perspective of node 36 are actually a unique Link Aggregation Group. The primary nodes 30, 32 are able to communicate with each other as they are connected by respective internodes ports 5, 6.

The inter-node connection can be made redundant using an alternative path between node 30 and node 32 using the resources made available by the first network 12.

The method 50 comprises determining 52 a service identifier associated with a packet received at one of the primary nodes 30 or 32 from the first network 12. This invention is concerned with data packets which are associated with a particular service. The first network 16 comprises a plurality of clients 38, 40, 42 to which one or more such services maybe provided. The services are managed by transfer of data packets between the first 12 and second 14 networks. The service identifiers which are associated with the data packets are arranged to identify the service to which the data packet relates.

The method 50 further comprises switching 54 the packet to the second network 14 using the respective second ports 1, 2 or 3, 4 of the primary node 30 or 32 at which the packet is received, or switching the packet to the other primary node 32 or 30 using the internode port 5 or 6 dependent on a service identifier associated with the packet.

Advantageously, the determination of the route along which the data packet will be switched to the second network is made dependent upon the service to which it relates. This provides an advantage over systems in which the packet route is dependent solely upon MAC addresses since there may be a large number of MAC addressed devices which are provided with a single service. Therefore, instead of keeping an index of routing requirements for each MAC addressed device at the switching nodes in order to manage the dual ended link aggregation arrangement between the first and the second network, it is possible to merely keep an index of routing requirements based upon a much smaller number of services. In this way, if for example indexing requirements are kept in the form of a lookup table, a much smaller lookup table would be required if data packet routing is dependent upon the service to which the data packet relates rather than the MAC addressed device to which it is destined. Also, methods which exclusively rely on MAC addresses must implement complicated measures to ensure that resiliency and loop avoidance are properly managed in the dual ended link aggregation connection between the first network and the second network. Indexing requirements may be implemented in different ways—i.e. other than in the form of lookup tables—however the principles remain the same. In a service identifier dependent system, processing which leads to data packet routing will be simplified, more efficient and less prone to error than in a MAC destination address based system.

As an example, in some embodiments the first network 12 comprises a metro network, and the second network 14 comprises an IP (internet protocol) network. In this example, typically there might be two million MAC addressed clients in the metro network, and perhaps five service entities, (e.g. video, Voice Over Internet Protocol (VOIP), internet and two other such services), which are provided to the clients in the metro network. When a data packet is received at a one of the primary nodes 30 (which are involved in the dual ended link aggregation arrangement) for subsequent switching or forwarding, MAC address destination information is recognised in order to go through the second network 14 (and therefore over the link aggregation group 20, 21), according to the normal MAC learning process. According to the method of this invention, a decision as to which route the data packet should take based upon the service to which it relates may require interrogation of a lookup table containing only five entities referenced by their service identifiers. In comparison, if the decision is made based exclusively upon the MAC address of the client, the link aggregation arrangement needs to be managed using a far higher number of entries (two million in our example), and may be constantly or occasionally changing in its form as clients are added or removed over time, possibly fairly regularly. In this respect the amount of information that nodes 30 and 32 need to exchange is significantly higher and far more complex to be managed.

In one example, the data packets are Ethernet packets and the service identifier comprises a VLAN (virtual local area network) identification tag.

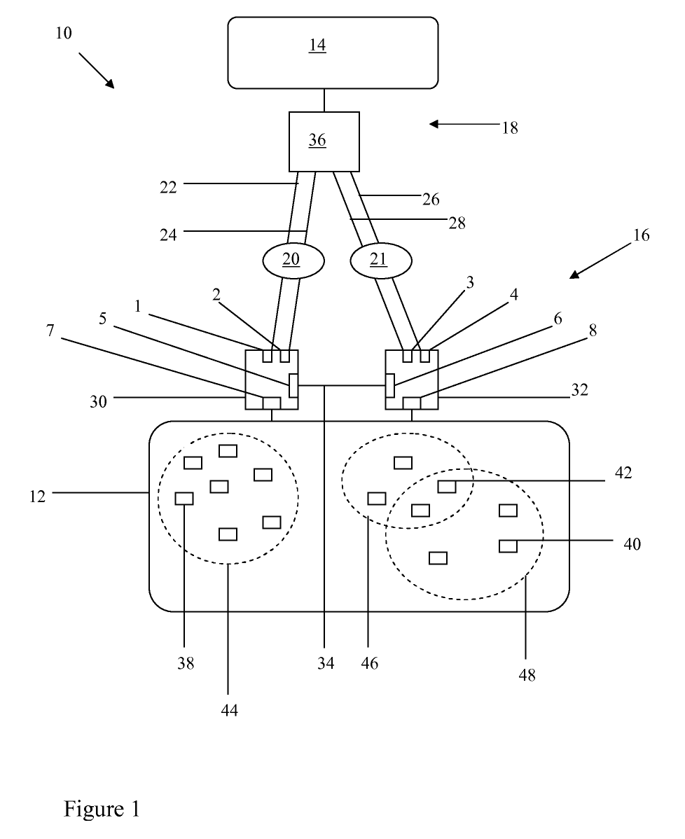

Referring to FIG. 1, in one particular embodiment, there is shown a system 10 including the second network 12, which includes a plurality of clients, including clients, 38, 40, 42 which are provided with three services—including Voice Over Internet Protocol 44, internet 46 and video 48. Client 38 is provided with VOIP 44, client 40 is provided with video 48 and client 42 is provided with both video 48 and internet 46.

The system 10 includes a first node arrangement 16 which is connected to the first network 12. The first node arrangement 16 comprises the primary nodes 30, 32. The system 10 also includes a second node arrangement 18 which is connected to the second network 14 and which comprises the secondary node 36.

Data packets relating to the services may travel from the first network 12 to the second network 14 or from the second network 14 to the first network 12. At the primary nodes 30, 32 the processing of the traffic destined to the second network is made efficient (as previously discussed) since it is based upon service identifiers associated with the data packets travelling through the system 10. In one example, the primary nodes comprise switches 30, 32 and the secondary node comprises a router 36. Between the respective second ports 1, 2 and 3, 4 of the switches 30, 32 and the router 36 are a plurality of physical links 22, 24, 26 and 28. The physical links are arranged into link aggregation groups 20, 21 in a conventional manner for the router 36. In fact the only requirement that router 36 is required to support is to have a distribution function on to the LAG ports based on the service identifier. The router 36 is required to be able to operate with the conventional link aggregation technology and is not required to form any additional processing or functions in order to be compatible with the present invention. Therefore, existing network architecture (routers) can be used to implement the present invention.

Referring to FIG. 3, according to another embodiment of the invention packets related to a particular service are permitted to be switched by the second ports 1, 2 or 3, 4 of only some of the primary nodes 30, 32. In this particular example packets related to a particular service are permitted to be switched via the second port 1, 2 of only one primary node—namely the switch, 30. The method 50 further comprises the primary nodes 30, 32 communicating 56 with each other details of which of the primary nodes (in this example, switch 30) are permitted to switch packets related to a particular service. So, in this example switch 30 is permitted to switch packets related to the internet service 46, whereas switch 32 is not permitted to switch packets related to the internet service 46 towards the second network. This is true at any particular instance in time. Subsequently this permission might change, but it will remain true in this particular example that only one of the primary nodes 30, 32 will be permitted to switch packets relating to the internet service 46.

Referring to FIG. 5, there is shown a logic diagram showing the processing which takes place at the primary node 30, 32 when a data packet is received. In this particular example, if a data packet relating to the internet service 46 is received at the switch 30, after having realised that it is destined to the standard network, initially the service identifier of the packet is checked in order to identify that it relates to the internet service 46. Next, a determination is made as to whether the switch 30 is permitted to switch packets related to the internet service. As indicated above the switch 30 is permitted to switch packets related to the internet service 46, and so the packet is switched using the second ports 1, 2 of the switch 30 according to the above-mentioned distribution method. Optionally, in some embodiments, data packets relating to a particular service, e.g. the internet service 46, are permitted to be switched from only a single port, for example port 1, of a switch (in this example, switch 30).

It is noted that the secondary node 36 is not required to be aware of the protection scheme, but is only required to support standard Link Aggregation. The only requirement that this invention puts on the secondary node 36 is to be able to operate Link Aggregation without Link Aggregation Control Protocol (LACP) and to use a distribution mechanism based on the service instance (e.g. VLAN). This is because the secondary node 36 sends the traffic related to a given service to the primary nodes 30 and 32 using only one of the ports which compose the Link Aggregation Group (20, 21).

Returning to the illustration of FIG. 5, if instead a data packet relating to the internet service 46 is received at the switch 32, then in this case the service identifier is checked and it is determined that the switch 32 is not permitted to switch to the secondary network packets related to the internet service 46. Therefore, the packet is switched to switch 30 since switch 30 is permitted to switch to the secondary network the internet service related data packet. The inter-node port 6 is used to send the data packet to the inter-node port 5 on switch 30 via an inter-node communication line 34, which runs between the inter-node ports 5, 6.

Optionally nodes 30 and 32 can have an alternative path to communicate between them using the resources of network 12, so that higher reliability can be achieved.

In this example, the inter-node communication line 34 is used to transfer from switch 30 to switch 32 (and vice versa) information relating to details of which of the primary nodes 30, 32 are permitted to switch packets related to any of the particular services. In this example, this information may be kept in the form of a lookup table which is maintained at both the switch 30 and the switch 32. As soon as a change is made to the lookup table at one of the switches, the other switch is notified of the change so that the other switch's lookup table can be updated. The information which needs to be stored in this look up table is only related to the ownership (i.e. the permission to switch the traffic towards the second network) on a given service, hence it is minimal.

Referring to FIG. 4, in one embodiment, the method 50 comprises permitting 58 a switch to switch packets relating to a particular service upon receipt of a packet relating to that service from the router 36. For example, in such embodiments, whenever a packet relating to a service is received at one of the primary nodes 30, 32 from the router 36, that primary node becomes the node responsible for switching packets relating to that service. Since the traffic related to any one service is sent over a unique port by the router 36, only one between nodes 30 and 32 can receive such traffic at a given moment in time, and hence be responsible to forward it from the first to the second network at any one time. For example, if switch 30 is permitted to switch internet service 46 traffic, but the other switch 32 receives an internet service 46 packet from the router 46, then said other switch 32 obtains permission via step 58 of the method 50 to switch packets relating to the internet service 46. Subsequently, the switch 32 notifies switch 30 that it has obtained permission to switch internet service packet and so switch 30 is no longer permitted to switch such packets towards the second network 14. This permission setting action applies for traffic travelling from the second network 14 to the first network 12 and not vice versa. This is because it is desirable that the secondary node 36 is not required to be aware of the protocol of the present invention. In some examples, the secondary node 36 will generally perform higher level processing than the primary nodes 30, 32 and so, advantageously, the secondary node 36 can be left to carry out higher level protocols and processing without having to divert its resources towards implementation of the method of this invention. Also advantageously, the method of this invention can be easily implemented with existing secondary nodes, e.g. routers 36 which generally carry out higher level protocol implementation than primary nodes, e.g. switches 30, 32 which are attached to metro networks.

In general, conventional load balancing algorithms will split traffic along the link aggregated groups 20, 21, which are seen like a unique logical link (LAG) by router 36, such that traffic relating to a particular service will be directed to the same ports 1, 2, 3, 4 of the same switch 30, 32 each time traffic is sent from the second network 14 to the first network 12. This may not be the case if traffic in the link aggregated groups 20, 21 needs to be reconfigured for any reason—for example after a failure in one of the link aggregation groups 20, 21 or at one of the nodes (primary nodes or secondary nodes). It will be apparent that in some embodiments there may be more than one secondary node in the second node arrangement 18. Similarly, there may be more than two primary nodes in the first node arrangement 16. The principles of the invention can be logically extended indefinitely with more such components.

In the case of initial set up of a totally new network, or more likely in the case of reconfiguration after a failure, or replacement or maintenance of the nodes, it may be the case that none of the primary nodes 30, 32 have yet been assigned permission to switch packets relating to a particular service. In this case, the first of the primary nodes 30, 32 to receive a packet from either of the networks 12 or 14 will check the service identifier of the data packet and assume responsibility for the service to which that data packet relates. For example, if none of the primary nodes 30, 32 is registered as having permission for internet service 46 packets, and such a packet is received from a client in the first network 12 at the switch 32, then switch 32 obtains sole permission to switch internet service 46 data packets towards the second network. Switch 30 is notified of this in the manner described above. Subsequently, internet service 46 data packets may be received at either of the switches 30, 32 from the router 36 since the router 36 is not concerned with such permissions—it simply relies on normal link aggregation distribution policy, which is service-based, for sending data traffic to the primary node 30, 32. Therefore, it may be that internet service data packets 46 are actually sent by the router 36 to the switch 30. At this point, as described above, switch 30 will become responsible for internet service 46 data packets and will notify switch 32 of this fact. Subsequently, it is expected that during normal operation of the system 10, the router 36 will continue to send internet service 46 data packets to switch 30 in line with the above-described policy until rearrangement needs to be performed (for example due to some failure or reorganisation—e.g. adding or removing ports from the link aggregation group—as mentioned above).

Various modifications may be made to the present invention without departing from its scope.

1. A method of transferring data packets between a first network and a second network using a node arrangement having at least two primary nodes connected to the second network, each primary node being connected to the first network using a respective first port and to a secondary node coupled to the second network using respective second ports arranged into respective link aggregation groups; the primary nodes connected by respective inter-node ports; the method comprising:
determining a service identifier associated with a packet received at a said primary node from the first network; and
switching the packet to the second network using the respective second ports or to the other primary node using the inter-node port dependent on a service identifier associated with said packet.

2. The method of claim 1 wherein packets related to a particular service are permitted to be switched via the second ports of only some, possibly only one, of the primary nodes and the method comprising the primary nodes communicating with each other details of which of the primary nodes are permitted to switch packets related to a particular service.

3. The method of claim 1 wherein packets related to a particular service are permitted to be switched by the secondary node to a single port of one of the primary nodes.

4. The method of claim 2 comprising permitting a primary node to switch packets relating to a particular service upon receipt of a packet relating to that service from the secondary node.

5. The method of claim 4 wherein the packets comprise Ethernet packets and the service identifier comprises a VLAN identification tag.

6. A node arrangement for coupling a first network to a second network, the node arrangement comprising:
at least two primary nodes connected by respective inter-node ports;
each primary node arranged to connect to the first network using a respective first port, each primary node being arranged to connect to a secondary node coupled to the second network using respective second ports, wherein the respective second ports of each primary node are arranged into respective link aggregation groups; and
each primary node being further arranged to switch packets from the first to the second network using the respective second ports or the inter-node port to the other primary node dependent on a service identifier associated with each said packet.

7. The node arrangement of claim 6 wherein packets related to a particular service are permitted to be switched via the second ports of only some, possibly only one, of the primary nodes and wherein the primary nodes are arranged to communicate with each other details of which of the primary nodes is permitted to switch packets related to a particular service.

8. The node arrangement of claim 6 wherein upon receipt at a primary node of a packet relating to a particular service from the secondary node, that primary node is subsequently permitted to switch packets relating to a particular service.

9. The node arrangement of claim 6 wherein the packets comprise Ethernet packets and the service identifier comprises a VLAN identification tag.

10. A system for coupling a first network to a second network, the system comprising:
a first node arrangement in communication with the first network;
a second node arrangement in communication with the second network;
the first node arrangement comprising at least two primary nodes connected by respective inter-node ports, each primary node arranged to connect to the first network using a respective first port;
the second node arrangement comprising a secondary node arranged to connect to the second network;
wherein each primary node comprises respective second ports arranged to connect to the secondary node, wherein the respective second ports of each primary node are arranged into respective link aggregation groups; and
wherein each primary node is further arranged to switch packets from the first to the second network using the respective second ports or the inter-node port to the other primary node dependent on a service identifier associated with each said packet.

10. (canceled)

12. The method of claim 1 wherein the primary nodes comprise switches and the secondary node comprises a router.

13. The node arrangement of claim 6 wherein the primary nodes comprise switches and the secondary node comprises a router.

14. The system claim 10 wherein the primary nodes comprise switches and the secondary node comprises a router.
